(19) United States
(12) Patent Application Publication
(10) Pub. No.: US 2015/0073870 A1
(43) Pub. Date: Mar. 12, 2015

(54) CROWDSOURCED INITIATIVES TRACKING, DEVELOPMENT, EVALUATION AND SCORING

(71) Applicant: Shahid N. Shah, Silver Spring, MD (US)

(72) Inventor: Shahid N. Shah, Silver Spring, MD (US)

(73) Assignee: NETSPECTIVE COMMUNICATIONS LLC, Silver Spring, MD (US)

(21) Appl. No.: 14/025,493

(22) Filed: Sep. 12, 2013

(51) Int. Cl. G06Q 30/02; G06Q 50/18

(52) U.S. Cl. CPC G06Q 30/0203; G06Q 30/0206; G06Q 50/184
USPC 705/7.32

(57) ABSTRACT

An initiatives exchange ecosystem includes a computing device operatively connected to a crowdsourced initiatives exchange network. The initiatives include an innovation and corresponding sub-innovations such that each innovation tracks sub-innovations. The ecosystem further includes a web platform accessible through a user interactive interface through the computing device and a processing circuit. The processing circuit includes an initiatives tracking engine that develops or tracks sub-innovations corresponding to an innovation in the crowdsourced initiatives exchange network. The initiatives are developed or tracked by performing a set of automated tasks aiming to change configurations of a parent innovation in at least one of the attributes or elements such that the resulting sub-innovation is different from the parent innovation in at least one of the categories.

### BACKGROUND

1. Technical Field

The embodiments herein generally relate to initiatives tracking, developing, evaluation, and scoring, and in particular to crowdsourced tracking, developing, evaluation, and scoring of sub-innovations corresponding to innovations.

2. Description of the Related Art

Many organizations and agencies give financial aids and rewards such as grants etc. for valuable ideas. However, in many of the cases, the organizations are not always sure about how to choose the most valuable ideas out of a set of innumerable ideas submitted for evaluation. This makes the evaluation process difficult by these organizations. Further, companies generally have hard time to track and/or develop valuable and creative global innovations and initiatives.

Therefore, there is a need for a method and system for initiatives tracking, development, evaluation, review and scoring of the initiatives and calculating financial rewards for the developed or tracked initiatives such as innovations and sub-innovations accordingly.

### SUMMARY

An embodiment herein provides an initiatives exchange ecosystem. The ecosystem includes a computing device operatively connected to a crowdsourced initiatives exchange network. The initiatives include an innovation and corresponding sub-innovations such that each innovation tracks sub-innovations. The ecosystem further includes a web platform accessible through a user interactive interface through the computing device and a processing circuit. The processing circuit includes an initiatives tracking engine that develops or tracks sub-innovations corresponding to an innovation in the crowdsourced initiatives exchange network. The initiatives are developed or tracked by performing a set of automated tasks aiming to change configurations of a parent innovation in at least one of the attributes or elements such that the resulting sub-innovation is different from the parent innovation in at least one of the categories including physical property, chemical property, biologic property, end usage, functionality, portability, cost effectiveness, and product type and bear a similarity relationship thread with the parent invention. The ecosystem further includes a central initiatives management engine that includes an evaluation module for evaluating the initiatives based on one or more inputs and a scoring module for associating a score to each of the initiatives based on an evaluation output. The ecosystem further includes an enterprise asset library to serve as a knowledge repository for storing information pertinent to the initiatives including initiatives documents, invention disclosures, innovator profiles, innovator credentialing details, the evaluation output, and the associated scores. The ecosystem further includes a financial transaction engine coupled to the processing circuit for exploring a plurality of target agency requirements within and outside the initiatives exchange network, determining a degree of relevance of an initiative with the target agency requirements, and determining a financial value of the initiative for the target agency. The ecosystem further includes an initiatives transfer engine for facilitating transfer of rights associated with the initiatives once the financial transaction is settled.

An embodiment herein provides a method for tracking or developing and scoring sub-innovations from an innovation in an initiatives exchange ecosystem. The method includes developing or tracking sub-innovations corresponding to an innovation in the crowdsourced initiatives exchange network. The initiatives are developed or tracked by performing a set of automated tasks aiming to change configurations of a parent innovation in at least one of the attributes or elements such that the resulting sub-innovation is different from the parent innovation in at least one of the categories including physical property, chemical property, biologic property, end usage, functionality, portability, cost effectiveness, and product type and bear a similarity relationship thread with the parent invention. The method further includes evaluating the initiatives based on one or more inputs. The one or more inputs include credentialed score, officiality, and reputation of the innovator, novelty search output, non-obviousness decision, significance of the initiatives for a target agency, revenue potential, and market coverage. The method further includes associating a score to each of the initiatives based on an evaluation output. The score may be outputted to a computing device.

An embodiment herein provides a program storage device readable by computer, and comprising a program of instructions executable by the computer to perform a method for tracking or developing and scoring sub-innovations from an innovation in an initiatives exchange ecosystem. The method includes developing or tracking sub-innovations corresponding to an innovation in the crowdsourced initiatives exchange network. The initiatives are developed or tracked by performing a set of automated tasks aiming to change configurations of a parent innovation in at least one of the attributes or elements such that the resulting sub-innovation is different from the parent innovation in at least one of the categories including physical property, chemical property, biologic property, end usage, functionality, portability, cost effectiveness, and product type and bear a similarity relationship thread with the parent invention. The method further includes evaluating the initiatives based on one or more inputs. The one or more inputs include credentialed score, officiality, and reputation of the innovator, novelty search output, non-obviousness decision, significance of the initiatives for a target agency, revenue potential, and market coverage. The method further includes associating a score to each of the initiatives based on an evaluation output.

### BRIEF DESCRIPTION OF THE DRAWINGS

The features of the disclosed embodiments may become apparent from the following detailed description taken in conjunction with the accompanying drawings showing illustrative embodiments herein, in which:

FIG. 1 illustrates generally, but not by way of limitation, an exemplary ecosystem in which various embodiments may operate;

FIG. 2 illustrates an example of the central initiatives management system among other things, in accordance with an embodiment herein;

FIGS. 3 through 5 depict exemplary embodiments of a credentialing system, among other things, for determining credentialed expertise of an innovator in accordance with various embodiments;

FIG. 6 illustrates an exemplary initiatives tracking engine for developing or tracking sub-innovations by each of the innovations in the crowdsourced initiatives exchange network;

FIG. 7 illustrates a method flowchart for tracking or developing and scoring of sub-innovations from an innovation in the initiatives exchange ecosystem; and

FIG. 8 illustrates generally, but not by the way of limitation, a computer system that may be used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

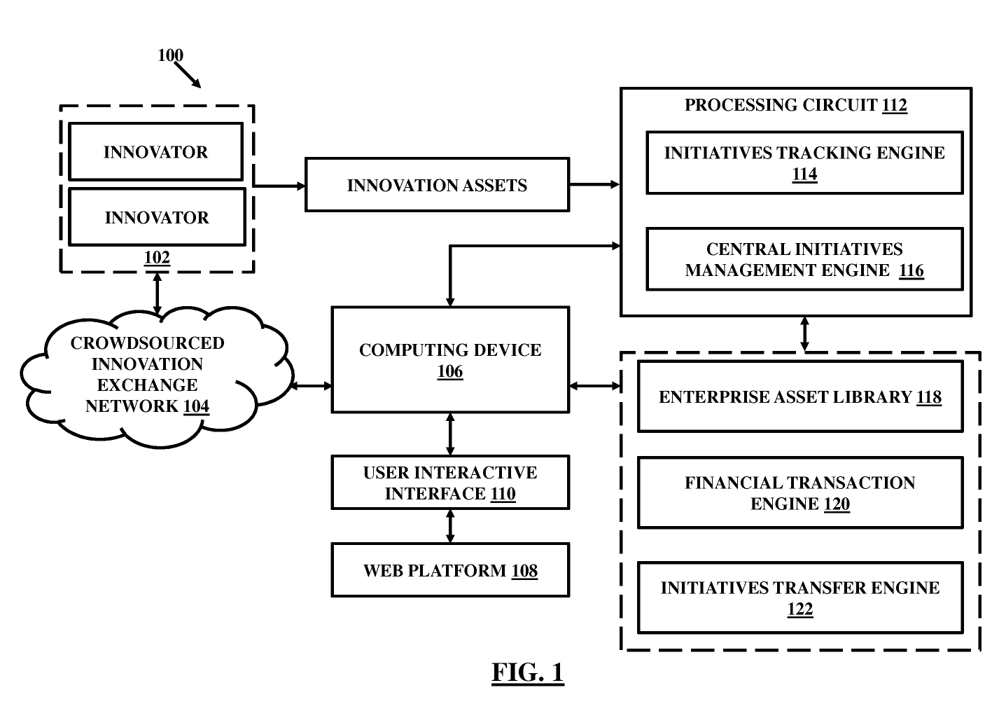

FIG. 1 illustrates an example of an initiatives exchange ecosystem 100. The ecosystem 100 includes a plurality of crowdsourced innovators 102 operatively connected with a crowsourced initiatives exchange network 104. The initiatives exchange ecosystem 100 is configured to track or develop initiatives in the crowdsourced network 104. The initiatives may include innovations and sub-innovations. The tracking of innovations or initiatives may include tracking or developing of sub-innovations based on parent innovations or other sub-innovations associated with the innovations. In some embodiments, each innovation tracks respective sub-innovations. In some embodiments, the ecosystem 100 may further perform tasks of innovation rating, milestones tracking and scoring. The ecosystem 100 may facilitate tracking of innovations and sub-innovations globally in a simplified and automated manner.

The ecosystem 100 includes a computing device 106 operatively connected to the crowdsourced initiatives exchange network 104. The computing system 106 may include systems such as desktop or laptop computers, workstation computer systems, server computer systems, networks of computer systems, personal digital assistants (PDAs), wireless communications devices, portable devices, or any other electronic data processing system. The computing system 106 can include hardware/software devices capable of computational tasks associated with tracking or developing or scoring or evaluating the initiatives as will be discussed later. These tasks can be performed through stand alone application, via Web browser graphical user interface (GUI), or via a Rich Internet Interface (RII). An embodiment herein may be implemented as computer software incorporated as part of the ecosystem 100. The ecosystem 100 further includes a web platform 108 accessible through a user interactive interface 110 through the computing device 106. The computing device 106 is operatively connected with a processing circuit 112. The processing circuit 112 includes or is coupled to an initiatives tracking engine 114 that develops or tracks sub-innovations corresponding to an innovation in the crowdsourced initiatives exchange network 104. The initiatives tracking engine 114 tracks or develops initiatives such as innovations based on for example parent innovations to result in sub-innovations corresponding to the innovations. The initiatives tracking engine 114 may utilize several types of algorithms and automated tools for enabling each innovation to track sub-innovations. The automated tools may for example perform tasks such as elimination, unifications, rearrangement etc. as will be discussed later.

The ecosystem 100 further includes a central initiatives management engine 116. The central initiatives management engine 116 performs various control and managing operations for the various innovations and tracked sub-innovations by each of the innovations. In an embodiment, the central initiatives management engine 116 creates a collated list of initiatives, innovation documents, invention disclosures, innovators' profiles, manage details about credentialed expertise of each of the innovators, classify initiatives under various technology or initiative classes, and maintain record of the initiatives in an enterprise asset library 118. The enterprise asset library 118 serves as a knowledge repository for storing information pertinent to the initiatives including initiatives documents, invention disclosures, innovator profiles, innovator credentialing details, evaluation output corresponding to the initiatives, and the associated scores for innovations and sub-innovations tracked by each of the innovations. The innovation asset library stores innovator profiles, wherein each of the profiles comprises a common profile and a plurality of associated federated profiles for each common profile as will be discussed later.

The processing circuit 112 may further include or be coupled to a financial transaction engine 120. The financial transaction engine 120 may explore a plurality of target agency requirements for one or more initiatives within and outside the initiatives exchange network 104. The transaction engine 120 may further determine a degree of relevance of an initiative with the target agency requirements. The financial transaction engine 120 may determine a financial value of the initiative for the target agency based on financial assessments and calculations utilizing the degree of relevance and value of the initiatives as inputs among other inputs without limitations.

The processing circuit 112 may further include or be coupled to an initiatives transfer engine 122 for facilitating transfer of rights associated with the initiatives once a financial transaction is settled between a target agency and an innovator or a service provider who may own the initiative.

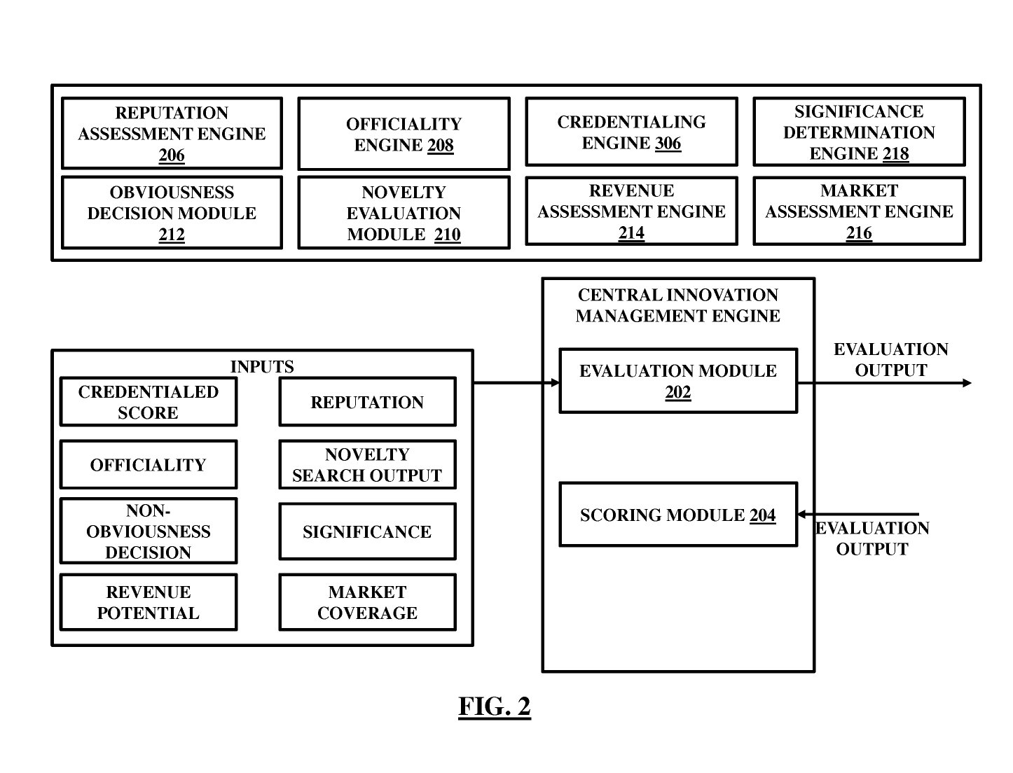

FIG. 2, with reference to FIG. 1, illustrates an example of the central initiatives management system 116 among other things, in accordance with an embodiment herein. The central initiatives management engine 116 includes an evaluation module 202 and a scoring module 204. The evaluation module 202 evaluates the initiatives based on one or more inputs. The inputs may include credentialed score of an innovator, index of crowdsourcing, officiality of the innovator, and reputation of the innovator, novelty search output, non-obviousness decision, significance of the innovation for a target agency, revenue potential, and market coverage, and the like. The various inputs for determining the score of the innovator are discussed herein.

The crowdsourced credentialing may be indicative of a degree of credentialing by a plurality of respondents, for example it may be indicative of a score obtained by the expert or reviewer on the basis of credentialing of the expert or an expert profile by a plurality of respondents. The crowdsourcing index may be indicative of the level of crowdsourcing that is the number of respondents credentialing the expert. In an embodiment, the effect of crowdsourcing index for an expert may define a non-linear relationship between number of respondents credentialing an expert and a score of an expert thus obtained. For example, the relationship can be exponential.

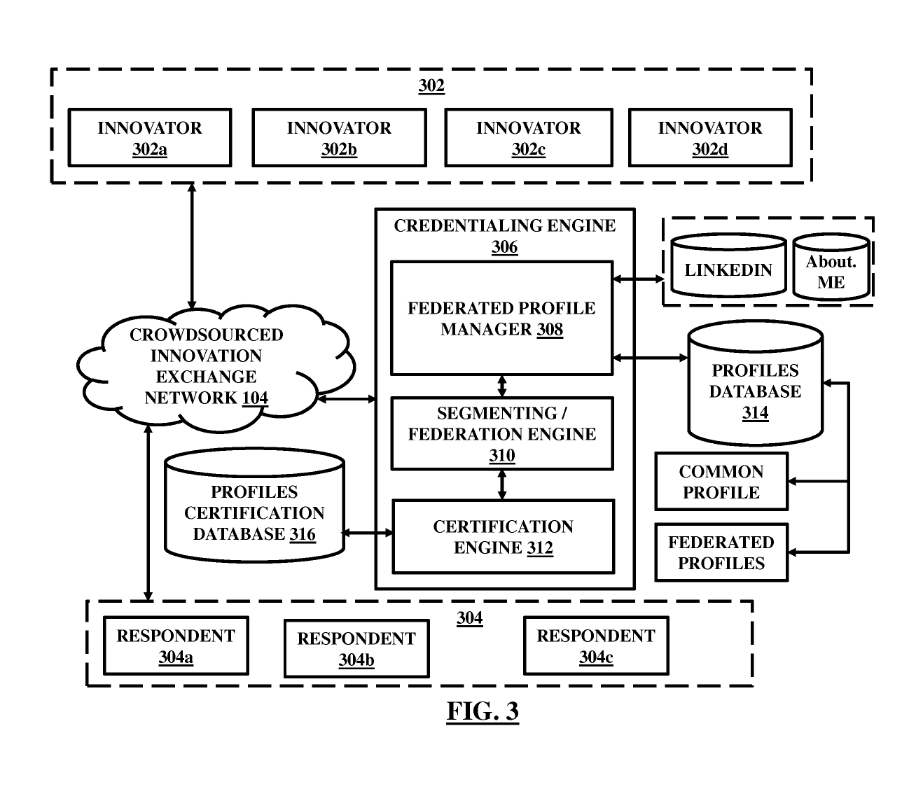

FIGS. 3 through 5, with reference to FIGS. 1 and 2, depict exemplary embodiments of a credentialing system or engine 306, among other things, for determining credentialed expertise of an innovator in accordance with various embodiments.

FIG. 3, with reference to FIGS. 1 and 2, illustrates generally, but not by the way of limitation, among other things, an exemplary operating environment for crowdsourced credentialing of innovators. The environment includes a plurality of innovators 302a-302d (together referred to as 302) and a plurality of respondents 304a-304c (together referred to as 304) operatively connected in a crowdsourced network 104. The credentialing system or engine 306 is operatively connected with the network 104 and is accessible by the experts 302 and the respondents 304 through the network 104 using for example a web-based interface or portal (not shown in FIG. 2).

The network 104 can employ a wireline or a wired communication channel or both. The wireless communications network may include for example, but not limited to, a digital cellular network, such as Global System for Mobile Telecommunications (GSM) network, Personal Communication System (PCS) network, or any other wireless communications network. The wire line communications network may include for example, but not limited to, a Public Switched Telephone Network (PSTN), proprietary local and long distance communications network, or any other wire line communications network. In addition, the network 106 may include for example, digital data networks, such as one or more local area networks (LANS), one or more wide area networks (WANS), or both LANS and WANS to allow interaction with the credentialing system 306. One or more networks may be included in the crowdsourced network 104 and may include both public networks such as the Internet, and private networks and may utilize any networking technology and protocol, such as Ethernet, Token Ring, Transmission Control Protocol/Internet Protocol (TCP/IP), or the like to allow interaction with the credentialing system 306.

The experts 302 can include one or more of a physician, doctor, surgeon, healthcare expert, any other healthcare professional, or any other professional or expert from other industry such as energy, financial, transportation, logistics, and numerous other industries. The respondents 304 may include one or more of a physician, doctor, surgeon, healthcare expert, any other healthcare professional or healthcare organization such as a hospital, or any other professional or expert from other industry such as energy, finance, transportation, logistics, and numerous other industries, or any other person who may be interested in credentialing or accreditation process of the experts 302 or may be any person related to the experts 302 and who may provide a trusted response or comment on information about the experts 302 such as qualifications, work history and the like. A plurality of industry related or other agencies such as hospitals, nursing centers, research institutes, financial companies, financial agencies, transportation agencies, logistic companies, energy related agencies, and others or hiring agencies or placement agencies may also access the system 306 to receive credentialing or verification services provided by the system 306 for the plurality of experts 302. In such embodiments, the system 306 may provide the services to such agencies based on credentialing of the information of the experts 302 obtained by the respondents 304.

The experts 302, and respondents 304 may be operatively connected with, for example, any type of electronic data processing system or communication device or a client device operatively connected to the communications network. Examples of such an electronic data processing system or client device may include personal computer systems, such as desktop or laptop computers, workstation computer systems, server computer systems, networks of computer systems, personal digital assistants (PDAs), wireless communications devices, portable devices, or any other electronic data processing system. The client devices or data processing systems can include hardware/software computing devices capable of computational tasks associated with profile creation, modification, verification, and presentation and the like as will be discussed later. These tasks can be performed through stand alone application, via Web browser graphical user interface (GUI), or via a Rich Internet Interface (RII). An embodiment herein may be implemented as computer software incorporated as part of an online social networking system. The credentialing system 206 can operate with the client device using a Windows, Macintosh, UNIX, Linux or other operating system equipped with a Web browser application, or other Web-enabled device capable of connecting to the crowdsourced network 106.

The credentialing system 306 provides a technical capability and a federation model such that profiles of the experts 302 may be created including details about the experts 302 and stored in the system 306. The details may include demographic information, personal information, educational background, work history or any other similar information. These profiles can be shared with the plurality of respondents 304, and experts 302 based on set standards and preferences and rules to implement a federated exchange capability wherein distinct portions of the profiles can be credentialed or accredited or verified and shared or exchanged with the experts 302, respondents or 304 in a federated manner. The system 306 further provides a credentialing and verification and accreditation capability such that profiles of each of the experts 302 may be credentialed or verified or accredited by any other expert or the respondents 304 for the use of the credentialed profiles by other experts 302 or an agency or organization such that the entire credentialed information or profiles available and credentialed through federated sources is accessible at a single location from the system 306. In some embodiments, the system 306 further provides a capability to create a federated model of the profiles such that the federated segments or portions or profiles, as will be discussed later in detail, may be verified or credentialed distinctly by distinct federated respondents 304 in the crowdsourced network 104 such that the crowdsourcing increases the level of trust and authenticity and reliability of the credentialing and credentialed information due to cumulative effect of several federated verifications by the crowdsourced respondents 304 for the same segments of the profiles.

The credentialing system 306 as shown includes a federated profile manager 308, a segmenting or federation engine 310, and a certification engine 312 discussed below in detail.

The federated profile manager 308 is configured to receive information for profile creation from the plurality of experts 302. The federated profile manager 308 is responsible for maintaining the information thus received from the experts 302 and modify it as per updates from the experts 302. The federated profile manager 208 is configured to be linked to several sources of information that have experts' presence such as for example their social networks including social networking websites, their educational institutions, work environments and the like. The federated profile manager 308 collects information from a plurality of sources for each of the experts 302 and collates the records and information in the form of a single common profile of each of the experts 302 that are associated with and communicate with the system 306. The profile manager 308, for example may collect information from federated sources such as Linkedin, Myspace, About.Me, education institutions, workstations, and the like. The common profile maintained by the system 306 may be viewable by the experts 302, respondents 304, relevant organizations, or any other persons or entities associated with or subscribed to the system 306. In some embodiments, the federated profile manager 308 may automatically retrieve the profile information from the social networks. In other embodiments, the federated profile manager 308 may maintain information that is submitted by the experts 302 voluntarily.

The federated profile manager 308 may allow the experts 302 to maintain their profiles in the system 306 and protect the information in their profiles and their attention from inappropriate access, and makes their personal profiles connectable. The credentialing system 306 may further enable the profiles and information therein as searchable by the experts 302 and the respondents 304. In doing so, the experts 302 may use a web-based interface to access the user interface or portal of the system 306. The experts 302 can then create their profiles and update profile information using the user interface after an initial registration process. To register, the experts 302 may complete a registration page and enter a valid email address as a unique identifier, and a private password. The experts 302 may then set up their profiles and enter the information. The profile describes the user's background, experience, current and prior interests, capabilities, positions and titles, skills, values, projects, goals, employing organizations, working stations etc. The experts 302 can add contacts by entering contact and relationship information, and profile information for the contact, or a link to the contact's own profile on the system 306. The contact information may also be automatically uploaded or extracted from other sources such as an electronic address book, and authorized by the experts 302 for use in the credentialing system 306. The experts 302 may not want their address book integrated in the system 306. In this case, the experts' address book would be uploaded, but not integrated into the credentialing system 306 and possibly hidden from others. The profiles and contact information may be stored in either a central database or in distributed databases. For example, the system 306 may include or be coupled to a profiles database 314 that may store the information pertinent to the profiles of the experts 302.

In some embodiments, once an expert 302a joins the network 104 and subscribes with the credentialing system 306, the information included in the profiles is ready for credentialing, verification, accreditation, or any other such purpose. The entire profiles can thus be credentialed or verified by the system 306 from the plurality of crowdsourced respondents 304 such that the crowdsourced respondents 304 can verify the profiles and credential them. The credentialing may also determine the profiles as accurate or inaccurate, trustable or non-trustable, authentic or unauthentic, fraud or genuine, etc.

In other embodiments, once the plurality of experts 302 joins the network 104, the profiles are segmented into distinct portions or segments referred to as federated profiles by the federation or segmenting or federation engine 310. The segmenting engine 310 is configured to receive the common profiles from the profile manager 308 and segment them into the federated portions or segments or profiles. In an example, the federation engine 310 fragments a common profile of an expert into a plurality of federated profiles based on commonalities in content of the federated profiles. The federated profiles are treated as distinct profiles for the purpose of credentialing separately by the crowdsourced respondents 304. For example, a common profile P of the professional 302a may include the following details:

### Name: Amir A.

Age: 38 years

### Sex: Male

### Location: Texas, US

Education: B.S in Computer Science from Purdue University (1995)
M.S. in Computer Science from Purdue University (1997)
   M.B.A. in Strategic Management (2005) from Kellogg School of Management
   PhD, Competitive Strategies (2011) from Kellogg School of Management

### Certifications and Awards:

Certification by Microsoft

Certification of Proficiency in Networking Technologies

Best Student award in 1994 by Purdue University

### Work Experience:

ABC: 1997-2003

SDF: 2003-2005

XCV: 2011-now

For the purpose of simplicity of description, only some specific details are included as an example in the above profile, however several other details may also be included without limitations. The segmenting engine 210 may be configured to segment the profile into distinct federated profiles. In an example, the taxonomy of the profiles may be “official” and centrally managed or may be extended by any of the federation partners.

In some embodiments, the above common profile may be segmented by the segmenting engine 210 into several federated profiles as below:

### Segment 1: First Name—Amir

### Segment 2: Lat Name—A.

### Segment 3: Middle Name—Null

### Segment 4: Sex—Male

### Segment 5: Location (Area)—Texas

### Segment 6: Location (Country)—US

### Segment 7: Education—B.S.

Segment 8: B.S. in year—1995

### Segment 9: Education—M.S.

Segment 10: M.S. in year—1997
Segment 11: B.S. from University/Institute—Purdue University
Segment 12: M.S. from University/Institute—Purdue University

### Segment 13: Education—M.B.A

Segment 14: MBA from university/institute—Kellogg School of Management
Segment 15: MBA in year—2005
Segment 16: MBA specialization—Strategic Management

### Segment 17: Education—PhD

Segment 18: PhD from University/Institute—Kellogg School of Management
Segment 19: PhD in year—2011
Segment 20: PhD work—Competitive Strategies

### Segment 21: Certification—by Microsoft

Segment 22: Certification of proficiency
Segment 23: Certificate of Proficiency in stream—Networking Technologies

### Segment 24: Award: Best Student

Segment 25: Award of Best Student received in year—1994
Segment 26: Awarded by—Purdue University

### Segment 27: Work Experience—ABC

Segment 28: ABC tenure begins in—1997
Segment 29: ABC tenure ends in—2003

### Segment 30: Work Experience—SDF

Segment 31: SDF tenure begins in—2003
Segment 32: SDF tenure ends in—2005

### Segment 33: Work Experience—XCV

Segment 34: XCV tenure begins in—2011
Segment 35: XCV tenure ends in—continuing now

As discussed above, a single common profile is segmented by the segmenting engine 310 in thirty-five discrete federated profiles that are distinct in one or the other ways. In accordance with various embodiments, the segmenting engine 310 can be configured to segment a common profile in as many discrete federated profiles as possible. Therefore, the entire information contained in a common profile is segmented into several discrete federated profiles. For example, the above discussed common profile is converted into thirty-five such federated profiles. Upon segmenting, the federated profiles may be communicated to the federated profile manager 308. Thus, the federated profile manager 308 stores common profiles as well as federated profiles associated with the professionals or experts 302 in the profiles database 314.

The segmenting engine 310 may include hardware and software components capable of computational tasks associated with segmenting of the common profiles into the federated profiles. Once segmented by the segmenting engine 310, the federated profile manager 308 may further classify the federated profiles or segments into groups of federated profiles for the same experts 302 so that the groups may include similar federated profiles based on certain parameters. For example, the work experience related federated profiles 27, 30, and 33 that define different companies where an expert was employed and is employed may be grouped together do define another type of profile referred to herein as a sub-profile. Similarly, various other groups may be formed to create various other sub-profiles based on several possible combinations of the federated profiles or segments or profile portions. The credentialing system 306 thus can facilitate maintaining of the common profiles, sub-profiles and the federated profiles for the same experts thus providing a three level profile management facility. It must be appreciated that this document uses the term portion, segment and federated profile interchangeably without limitations.

The credentialing system 306 further includes the certification engine 312 coupled to the segmentation engine 310 and the federated profile manager 308. The certification engine 312 is configured to allow the plurality of crowdsourced respondents 304 to respond to the segmented and classified profiles associated with the plurality of experts 302 and credential them. The credentialing of each of the segmented portions or federated profiles associated with an expert 302a of the plurality of experts 302 contributes to credentialing of the entire profile of the expert 302a upon collation of the credentialed portions. For example, the exemplary profile as discussed above includes thirty-five segments. The credentialing of each of the segments influences overall credentialing of the entire common profile. Therefore, if all the thirty-five segments are credentialed and verified as correct by one or more respondents 304, a trust may be associated about the profile information and the information may be considered as true or authentic. As more and more persons or respondents from the plurality of crowdsourced respondents 304 verify the information in the federated profiles, the trust associated with the respective segments increases. Further, the crowdsourcing index may be associated to indicate and factor in the level of crowdsourcing. In an example, the crowdsourcing index may bear a non-linear such as exponential relationship with the number of respondents 304 crowdsourcing an expert 302. Therefore, the degree of reliability and trust may increase non-linearly as more and more respondents credential an expert. Therefore, the crowdsourcing may facilitate in credentialing more accurately and with a higher reliability of the federated profiles than that credentialed from only a few sources. Further, the overall accuracy of the common profile may be determined based on a cumulative effect of accuracy of each of the federated profiles. For example, if the first ten of the segments from the above common profile are verified and the remaining twenty-five segments are not verified due to no response from the respondents 304, this may not yield an overall high accuracy of the common profile and may still require credentialing and verification of the remaining segments but may be considered as acceptable to a certain extent. On the contrary, if the remaining twenty-five segments are rejected and verified as wrong information by the respondents 304, the overall common profile may be considered as inaccurate. Further, since the discrete federated profiles associated with an expert 302a are credentialed from the plurality of crowdsourced respondents 304, there may be a high level of accuracy in the credentialing and the credentialing may be considered as highly authentic and reliable.

The certification engine 312 is adapted to certify the stored federated profiles relating to the experts 302 such as physicians or other industry experts who must have their credentials verified for use by various agencies or for use in for example by the experts 302 themselves during filling and submission of forms to various companies for such as hiring purposes or other purposes or document review processes. The credentialing information related to a particular expert 302a desiring to use the embodiments herein is initially input in the form of a common profile and then segmented and credentialed separately for each of the federated profiles through the crowdsourced network of the plurality of respondents 304. Therefore, the credentialing information when credentialed for each of the federated profiles is more accurate and valid and acceptable than the common profile verified in entirety where special attention may not be paid to every record of the common profile. Secondly, the degree of acceptance of credentialing information is much higher through crowdsourcing than for a single verification by a single source. Therefore, according to some embodiments herein, number of sources credentialing a particular federated profile may be associated with each of the segments to indicate a level of accuracy of the credentialing information. For example, if a federated profile is credentialed and verified by eighteen sources in the network, it may be considered as highly acceptable. Also, the relevant information about credentialing such as who credentialed, when credentialed may also be associated with each credentialing of each of the segments so that an authenticity may be judged by associating an overall impact of the federated profiles' credentialing, number of times credentialed, and trust factor about the source who verified and relevance about the time when verified. Therefore, in such embodiments, a multi-scaled and cumulative score may be determined and multi-scaled and cumulative credentialing may be done based on the multi-scaled cumulative score determined. Further, since a single federated profile may be verified by the plurality of crowdsourced respondents 304, therefore the credentialing system 306 may determine an extent of inconsistency between several credentialing by several different respondents 304 for the same federated profile. In this manner, the system 306 may be configured to determine an index of inconsistency depending on distribution of differences across several credentialing by the several respondents 304. The credentialing system 306 may be configured to generate a map indicating extent and coverage of inconsistencies among the several responses and credentialing for the same federated profiles. The map together with the inconsistency index may facilitate in determination of a level of trust in the overall credentialing of the same federated profile. This process may be repeated for each of the federated profiles for a common profile of an expert such as 302a and thus may determine an overall index of inconsistency and overall distribution map and overall trust factor for the common profile.

In some embodiments, various organizations or agencies such as for example document reviewing and inventions or ideas evaluation agencies may use the credentialing information, index of inconsistency, and distribution map as obtained from the system 306. The credentialing information may include information such as who verified or credentialed, when verified, how many times verified, how many different and unique verifications, trust factor associated with each verification based on such as a respondent's relationship with an expert such as 302a or any other factor, and other similar information. In some embodiments, the credentialing information may be used by the experts 302 themselves so that they can use the credentialing information as a proof of expertise and submit it along with various application forms to companies, hiring agencies, firms, healthcare centers, hospitals or any other agency or organization, financial institutions, energy related companies, logistic companies, transportation companies, and the like. Various types of information such as demographic, personal work history, educational information, affiliation with hospitals or institutes etc. can be credentialed. The credentialed information may include such as person's name, address, practice specialties, appointment status, hospital associations, credentials (including educational background, internships, and residency programs), state licensing information, malpractice liability insurance information, and personal and professional references. This entire information may be stored in the profiles database 314 maintained by the federated profile manager 308.

In some embodiments, the certification engine 312 may be coupled to or may include a profiles certification database 316. The profiles certification database 316 may include the credentialing information as discussed above. In some embodiments, the profiles certification database 316 may be included within the profiles database 314 only, and thus a single database may include memory spaces for storing the profiles information and the certification or credentialing information.

In some embodiments, in creating the common profile and uploading profile information in the database, a separate application form may be completed for each professional participating in and using the benefits of the system 306. The information in the application form may be preferably provided to the profiles database 314, which may store experts' profile information using the system 306. The information may be stored as a series of logically organized experts' profiles and may be extracted as necessary during segmentation by the segmenting engine 310. In some embodiments, the process of segmenting may be initiated by the segmenting engine 310 automatically as and when new information is added or updated. In case the past information is modified, the segmentation task is performed again to update the federated profiles and perform credentialing of the updated federated profiles once again. In such cases, only relevant credentialing may be needed to be revised depending on the updates instead of rejecting the entire past federated profiles and credentialing information associated with them.

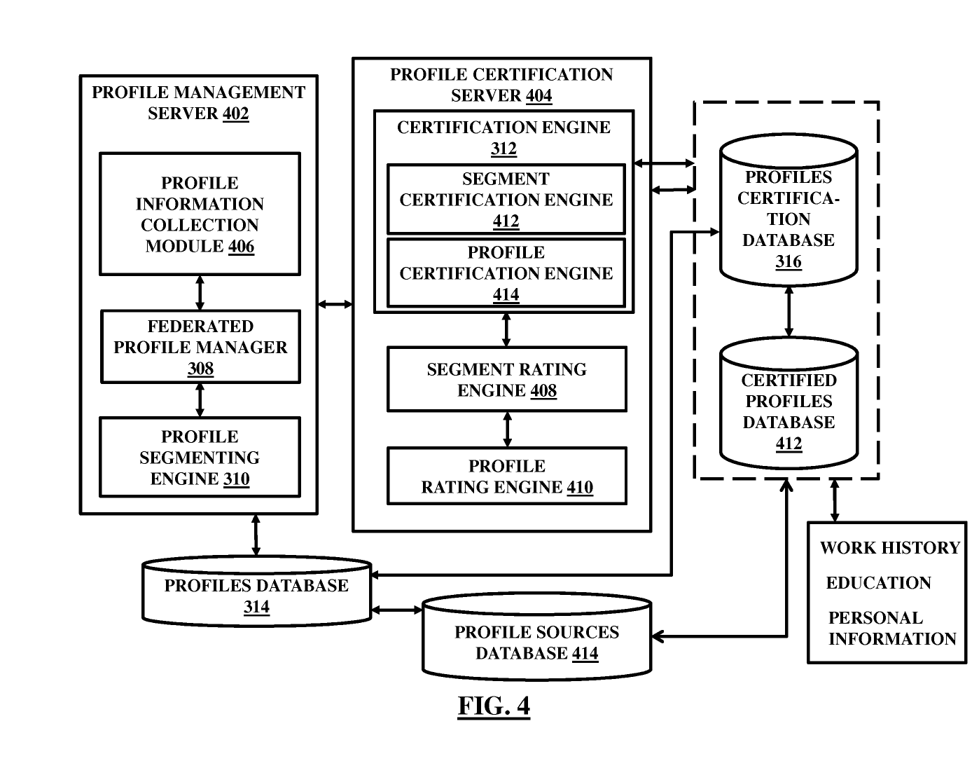

FIG. 4, with reference to FIGS. 1 through 3, illustrates the credentialing system 306 in accordance with an embodiment. As shown, the system 306 may include a profile management server 402 and a profile certification server 404. The profile management server 402 includes a profile information collection module 406, the federated profile manager 308, and the profile segmenting engine 310.

The profile information collection module 406 may be configured to generate information about the plurality of experts 302. In some embodiments, the profile information collection module 406 can be disposed separately from the federated profile manager 308; while in other embodiments it can be included in or coupled to the federated profile manager 308. The profile information pertaining to profiles of the plurality of experts 302 can be generated by distributing application forms through a graphical user interface accessible by the experts 302 such that the experts 302 can fill the forms and submit with the system 306. The information can be transformed in the form of profiles by the federated profile manager 308. The segmenting engine 310 may then use the profiles information and perform the task of segmenting of the common profiles into the federated profiles associated with each of the experts 302.

The profile certification server 404 may be communicatively coupled to or included in the profile management server 402. The profile certification server 404 may include the certification engine 312, a segment rating engine 408, and a profile rating engine 410. The certification engine 312 may further include a segment certification engine 412 and a profile certification engine 414.

The segment certification engine 412 may be configured to facilitate credentialing or certification of the federated profiles associated with the common profiles associated with each of the experts 302. The segment certification engine 412 is configured to allow the plurality of crowdsourced respondents 304 to respond to the federated profiles associated with the common profiles of the plurality of experts 302 and credential them. The credentialing of each of the federated profiles associated with the common profiles of each of the experts 302 contributes to credentialing of the entire common profile of the experts 302 upon collation of the credentialed federated profiles. As more and more persons or respondents from the plurality of crowdsourced respondents 304 verify the information in the federated profiles, the trust associated with credentialing of the respective federated profiles increases. Therefore, the crowdsourcing may allow credentialing of the federated profiles to a higher degree of accuracy and reliability. Since the discrete federated profiles associated with an expert 302 are credentialed from the plurality of crowdsourced respondents 304, the credentialing defines a high level of accuracy and may be considered as highly authentic and reliable and acceptable by third parties or agencies. Moreover, the crowdsourcing index may be associated to factor in the effect of crowdsourced credentialing as discussed above.

The segment certification engine 412 is adapted to certify the stored federated profiles relating to the experts 302 who must have their credentials verified. According to some embodiments herein, the number of sources credentialing a particular federated profile may be associated with each of the segments to indicate a level of accuracy of the credentialing information. Also, the relevant information about credentialing such as who credentialed, when credentialed may also be associated with each credentialing of each of the federated profiles so that an authenticity may be judged by associating an overall impact of the federated profiles' credentialing, number of times credentialed, and trust factor about the source who verified and relevance about the source and time when verified. Therefore, in such embodiments, a multi-scaled and cumulative score may be determined and multi-scaled and cumulative credentialing may be done based on the multi-scaled cumulative score determined.

The information pertaining to credentialing of the individual federated profiles of a particular common profile associated with an expert such as 302a may influence an overall credentialing of the common profile. For example, individual credentialing of the federated segments may contribute to the overall common profile credentialing such that the credentialing of the overall common profile may depend on each of the federated profiles' credentialing with a weightage attached to each credentialing of the federated profiles. The collated contribution considering weightage effect of each credentialing finally decides credentialing of the overall common profile. The task of credentialing the overall common profile associated with an expert such as 302a may be performed by the profile certification engine 414. For example, the profile certification engine 414 may facilitate credentialing of the profile in entirety based on the collated effect of credentialing of the federated profiles associated with the common profile of an expert such as 302a. The profile certification engine 414 may receive information pertinent to credentialing of each of the federated profiles associated with a common profile and then associate the defined weightages to each of the federated profiles and perform cumulative credentialing of the common profile. In an embodiment, the weightages may be determined based on parameters defined by a service provider who operates the system 306. In such embodiments, the weightages may be defined based on for example past experiences or current understanding about significance of accuracy of credentialing for different segments. For example, the accuracy of credentialing may be more important for work history than information pertinent to hobbies of a professional when applying for a job. Therefore, the objective use of the credentialing information may influence determination of the weightages and hence the overall credentialing. Therefore, a score indicative of the influence of the objective may be associated for the credentialing purposes in some embodiments. In some embodiments, the weightages may be defined by an agency requiring the credentialing information. Therefore, in such cases, the profile certification engine 414 may perform credentialing of the common profile in a custom defined manner and also in association with the objective score.

The profile certification server 404 further includes the segment rating engine 408. The segment rating engine 408 is configured to associate a rating to each of the credentialed federated profiles based on credentialing from the crowdsourced plurality of respondents 304 and depending on a level of accuracy and trust associated with the credentialing of the federated profiles. The rating may depend on who credentialed a federated profile, when was a profile credentialed, how many times a profile was credentialed, how many unique credentials are done, relevance of respondents 204 credentialing the federated profile, relationship of the respondents 304 with the expert such as 302a of the credentialed federated profile, and the like.

The profile certification server 404 may further include the profile rating engine 410. The profile rating engine 410 is configured to associate a rating to an entire profile based on credentialing of each of the federated profiles and ratings associated with each of the federated profiles as determined by the segment rating engine 408 cumulatively.

The profile management server 402 is coupled to the profiles database 314 to store information pertinent to the profiles of the plurality of experts 302. The profiles database 314 may be coupled to the federated profile manager 308 such that the federated profile manager 308 maintains the information stored in the profiles database 314.

The profile certification server 404 may be coupled to the profiles certification database 316. The profiles certification database 316 is configured to store information pertinent to credentialing such as certification status of the federated or common profiles associated with the plurality of experts 302. For example, the certification status may include one or more of verified segment, verified profile, pending verification, verification in progress, segment rejected as incorrect, profile rejected as incorrect and the like. The profiles certification database 316 may be coupled to the profiles database 314 and the certification engine 312.

The profile certification server 404 may be coupled to the certified profiles database 412. The certified profiles database 412 may further be coupled to the profiles certification database 316. The certified profiles database 412 may be configured to store profiles that have been verified by the certification engine 312. An entity or any other agency may be allowed a direct access to the certified profiles database 412 based on preferences and rules defined for the entity or the agency. The entity may be one of a medical entity such as a hospital, nursing center, doctor, physician, healthcare unit, and government healthcare department, or a financial institute, or a logistic company, or a transportation company, or a company in the energy sector, or any other third party or agency. The certified profile or credential database 412 may further store information pertinent to one or more of work history, education, and personal demographics, affiliations to hospitals or other institutes etc of one or more experts 302 corresponding to one or more of verified profiles.

The profiles database 314, profiles certification database 316, and the certified profiles database 412 may be coupled to a profiles sources database 414. The profile sources database 414 may include information about a plurality of sources in the crowdsourced network 104 that are linked to the federated profiles associated with the plurality of the experts 302, and information about a plurality of sources who responds to the federated profiles for credentialing. For example, in the crowdsourced network 104, the plurality of respondents 304 may credential the federated profiles and thus the profiles sources database 414 may store their details, their names, other information, their relevance and relationship with the experts 302 associated with the federated profiles they credential and time of credentialing, and location of original credentialing or any other such information pertinent to the credentialing sources etc.

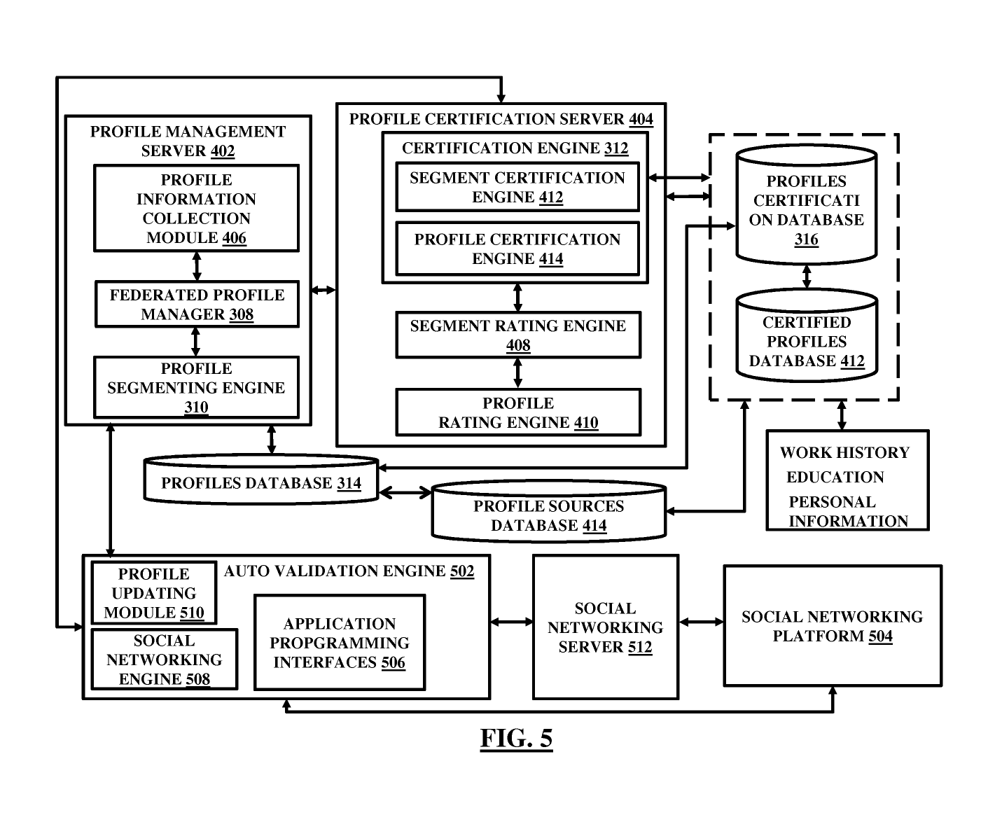

FIG. 5, with reference to FIGS. 1 through 4, illustrates another embodiment of the credentialing system 306. The credentialing system 306 may include the profile management server 402 and the profile certification server 404 as discussed above. The system 306 may further include an auto-validation engine 502 coupled to the profile certification server 404 and the profile management server 402. The auto-validation engine 502 is further communicatively linked to a social networking platform 504. The social networking platform 504 hosts information related to one or more of the experts 202. For example, the social networking platform 504 may host social profiles of the experts 302 where the experts 302 may store and update their personal, professional or other such details or may communicate in a social network with friends, relatives, family members, or other such networking contacts.

The auto-validation engine 502 is configured to further certify the credentialing of the federated profiles that is performed by the certification engine 312. The second level certification by the auto-validation engine 504 is performed by using the information about the one or more experts 302 from the social networking platform 504. For example, an expert such as expert 302a may be associated with a social networking website such as a Linkedin or Facebook. The expert 302a may maintain a separate profile for each such social networking website. The credentialing of the expert 302a for specific federated profiles may thus be further verified by using the information obtained from the social networking profiles.

In an embodiment, the credentialing by the respondents 304 is used to associate a rating and define a level of trust for the federated profiles and the common profiles. The further verification based on the information obtained from the social profiles of the experts 302 may further associate another rating or score to the federated profiles such that a level of trust about the plurality of experts 302 and their federated and common profiles may be determined based on a cumulative effect of credentialing and the auto validation of the federated profiles and the common profiles. The cumulative score determined based on individual scores from the auto validation and the credentialing by the respondents 304 may define a net rating and overall credentialing of the federated profiles and the common profiles. The federated profiles and the common profiles in association with the information pertinent to the credentialing and the auto-validation may thus be used or accessed by agencies or organizations or entities to determine a level of trust in the credentialed information; i.e., the credentialed federated and thus common profiles.

The auto-validation engine 502 may include application programming interfaces (APIs) 506, a social networking engine 508, and a profile updating module 510.

The social networking engine 508 is coupled to one or more social networking server 512. The social network engine 508, which may be controlled by the social network server 512, is configured to process a request of the credentialing system 306 for retrieving social profiles information and verifying the credentialed federated and common profiles by using the information obtained from the social profiles. The social networking engine 508 is communicatively coupled to the social networking platform 504 through the social network server 512 to allow interfacing of the system 306 with the social networking service or platform 504. The social network server 512 may provide a programmatic web interface via the network 104 for accessing the social profiles by the system 306. In some embodiments, the social networking server 512 may store social data related to the one or more experts 302 obtained from the social profiles hosted by the social networking platform 504 to integrate the social data with the credentialed federated profiles for further verification or updating of the credentialing by auto-validation.

The social networking engine 508 may utilize the APIs 506 etc. to allow verification of the federated segments associated with the plurality of experts 302 based on the information contained in the social profiles of each of the experts 302 maintained by the social networking platform 504. In an embodiment, the social profiles maintained by the social networking platform 504 are distinct from the federated or common profiles of the professionals or experts 302 maintained by the federated profile manager 308. The APIs 506 further allow the auto-validation to determine an extent of mapping between the information contained in the two distinct profiles maintained by the federated profile manager 308 and the social networking platform 504. The social networking platform 504 may include several social networking sources. The social networking sources may include without limitations social networking websites, educational institutions, employers' databases etc. For example, an expert such as 302a may be associated with one or more of such or other similar social networking sources in the social networking platform 504. The APIs 506 are adapted to link each of the federated profiles to one or more such distinct sources of the social networking platform 404 such that a unique identifier is maintained that associate a distinct source of the social networking platform 504 to a federated profile.

The profile updating module 510 is configured to update or modify the profiles based on further verification of the federated profiles after auto-validation. For example even after the credentialing by the respondents 304, the auto-validation may demand to modify the federated profiles which the profiles updating module 510 may do, in some cases after seeking permissions from the experts 302. The profile updating module 510 may be communicatively coupled to the profile management server 402 so as the federated profile manager 308 can store and maintain the modified federated and common profiles.

The social networking platform 504 may include for example one or more social networking sources. The sources may be such as social networking websites, educational institutions, employers' databases or portals or platforms, hiring agencies' portals, and other such sources of creating a socially aware network. Some examples of social networking websites are without limitations Linkedin, MySpace, About Me, etc.

A service provider may deploy the credentialing system 306 and provide credentialing services to various organizations or agencies that can be a hiring agency, recruitment and selection or placement department or agency, document or inventions or ideas reviewing and scoring and evaluation agencies, an entity such as a hospital or a medical institute, financial institute, logistic company, transportation company etc. The organizations such as document or inventions or ideas reviewing and scoring and evaluation organizations can deploy these systems in-house for evaluation of ideas or documents. An expert such as 302a may submit his profile details to the service provider that may be stored in the system 306. The service provider may obtain verifications and credentialing of the profile details or other information provided by the expert 302a and may store the information pertinent to the credentialing of the information of the expert 302a. The service provider may utilize a crowdsourced network 104 of people including such as the respondent 304a or authorizer 304a who may be any other expert or any of the respondents 304. The service provider, expert 302a and the respondent or authorizer 304a may connect with one another over the network 104 through a web-based graphical user interface that may serve as a portal for interconnection. The portal or interface may provide a subscription section through which the entities such as the expert 302a, agency, or the respondent/authorizer 304a may associate them with the credentialing system 306. Different sections may be provided for each to the expert 302a, respondent 304a, and agency. Upon subscription, the expert 302a may be allowed to submit his details to the system 306 and/or create a profile.

The profile information may be publicly visible in some embodiments or may be made visible to the specific respondent 304a by the service provider for credentialing purposes and receiving responses from the respondent 304a about the expert 302a. The profile information may be credentialed and verified in entirety or in segments as discussed above and may be stored in the system 306. The agency may thus know accreditation or credentialing about the expert 302a by visiting the portal through a separate section defined for such agencies. Therefore, through the web-based portal or interface, the agency may be facilitated to collect credentialing information and the authenticity about the expert's profiles and other information by visiting the single centralized system 306 and may not need to verify the details of the profiles from several sources such as workplaces, educational institutes etc. Further, since the system 306 performs credentialing from a crowdsourced network of experts 302, therefore, the accuracy of the credentialing and authenticity and reliability of the profiles' information may be higher and the agency can rely on the information with a greater degree of trust and reliability. Further, since the profile information is segmented into the federated profiles, therefore, the credentialing may be more specific to each of the information details contained in the federated profiles and the agency may easily know which information is verified and which is not or which may be pending for verification. In some embodiments, the agency may also know who verified a particular federated profile, when was a particular federated profile verified, and how many unique verifications are done for a specific federated profile. Therefore, with all these features provided through the present system 306, the credentialing may be made easier, quicker, trustable, reliable, accurate, and manageable.

Referring back to FIG. 2, with reference to FIGS. 1 and 3 through 5, reputation of an expert may be indicative of a trust of a relevant community on the expert 302a. The scoring module 204 may include or be coupled to a reputation assessment engine 206 that determines reputation of the experts 302 that indicate trust of relevant communities on the experts 302. In an example, reputation can be assessed based on experts' interaction with others on expert networking sites, information exchange platforms, and other knowledge interaction platforms. For example, an expert 302a may interact with a community including other experts in a relevant field for example medical equipment design through a knowledge platform. The interaction may be of the type of posting questions relevant to the field of medical equipment design, submitting answers to such questions posted by others, reviewing answers posted by others in response to such questions. Any such interaction may lead to building or loosing of reputation of an expert 302a who interacts. The ways of building or loosing of the reputation, together referred to as reputation assessment may be defined by the reputation assessment engine 206. The reputation assessment engine 206 may for example evaluate and assess reputation of an expert 302a based on quality of the questions posted by him, quality of the answers posted by him in response to questions posted by others, or quality of review performed by the expert 302a for answers submitted by others. The reputation in such cases may be assessed by calculating the number of positive votes from others in the community, number of negative votes in the community, neutral votes in the community to any kind of interactions by the expert 202a. In an embodiment, any positive vote (for example a like comment or remark or vote) for a question posted by the expert 302a may earn him 10 points of reputation, and any negative vote (such as any dislike remark, comment or vote) may cause the expert to lose 10 points from the reputation. In an embodiment, any positive vote on an answer posted by the expert may earn him 20 points and any negative vote on such an answer may cause him to lose 20 points. In an embodiment, any positive vote on a review of an answer by the expert may earn him 25 points and any negative vote by others in the community on such a review may cause him to lose 25 points. In other embodiments, various other ways of assessment of the reputation may be defined without limitations. In an example, the reputation of an expert 302a may be tied to a relevant field or a relevant community by the reputation assessment engine. For example, the reputation assessment engine 206 may allocate a reputation of 50 in the area or community of medical equipments design but the same expert 302a may be allocated a reputation of −20 in the field or community of medical devices programming. The reputation may be defined as positive value points as well as negative value points—the positive points defining a degree of increasing trust by the community, and the negative points defining a decreasing trust by the community.

In an example, the extent of trust may be identified through voting. For example, votes can be posted in integral or fractional numbers such as +3, +3.5, −2, −4.2, and the like. In this way, a net summation of all the votings weighted with reputation assessment parameters (such as mentioned above) that define how much reputation points are earned or lost with each interaction, may result in the reputation of an expert 302a for a particular field or community.

Once the reputation assessment engine 206 evaluates reputation of an expert 302a for a particular field or community (which is same as or similar to the field of the document under review), the document scoring module 204 may use the reputation of the expert 302a for determining score of the document by using the reputation as an expert attribute. In such cases, experts 302 and reputations of experts 302 that are from the same or similar fields or communities as that of the documents under review are considered only so as to establish trust and authority of the experts 302 by the relevant communities and use it as an indicator for validity and authenticity of documents review and scoring after aggregation of reputations from various such experts 302.

In some embodiments, the reputation assessment engine 206 may also be capable of aggregating various discrete reputations from individual crowdsourced experts 302 so as to determine an aggregate reputation for a group of crowdsourced experts 302 used in evaluation, reviewing and scoring of a document. The aggregate score may be a net equivalent score that can be associated with the crowdsourced experts 302 to indicate the reputation of the entire crowdsourced community of the experts 302 contributing toward document review and scoring.

The officiality is indicative of a position or a designation of an expert 302a in a relevant job. The scoring module 204 may include or be coupled to an officiality engine 208 that determines officiality of the experts 302. In an example, different hierarchical positions as an indicator of officiality may be associated with specific ratings that may be used to associate an officiality score to an expert 302a. The officiality engine 208 may determine such officiality scores for individual crowdsourced experts 302. In some embodiments, the officiality engine 208 may also be capable of determining an aggregate officiality score for a crowdsourced community of the experts 302 that contribute to review and scoring of the document. The aggregate score may be a net equivalent score that can be associated with the crowdsourced experts 302 as a group to indicate the officiality of the entire crowdsourced community of experts 302 contributing toward document review and scoring. In the context of the embodiments herein, officiality refers to a qualitative and/or quantitative evaluation assessment of the crowdsourced community of experts 302. This legitimizes the score provided by the experts 302.

The evaluation module 202 may be coupled to a novelty evaluation module 210. The novelty assessment module 210 provides a result quantifying one component of patentability. The novelty assessment or evaluation may be done by posting defined questions to a set of crowd in the crowdsourced network and receiving responses from them. In such cases, the crowd includes credentialed experts who may be considered only when they bear a threshold score of officiality, reputations and the credentialed expertise as already determined and discussed elsewhere in this document. The questions may be defined and rank ordered according to their perceived importance for the initiative or sub-innovation under evaluation. Based on the rank, questions may be scored in a weighted fashion. For example, the patentability question of rank order 1 can contribute more to the patentability score than the patentability question of rank order 5. The assessment and evaluation is designed to yield a minimum threshold score to qualify an innovation or a sub-innovation or any other initiative as novel. In some embodiments, the novelty assessment may be done by the novelty evaluation module 210 by utilizing machine learning and automated search capabilities that result in identification of prior art relevant to various initiatives under consideration including the tracked sub-innovations.

The evaluation module 202 may be coupled to an obviousness decision module 212 that may be used to assess uniqueness of an initiative such as an innovation or a sub-innovation regarding its non-obviousness with reference to corresponding parent innovation of a sub-innovation. The obviousness decision module provides a result quantifying another component of patentability—that is non-obviousness. The obviousness decision or evaluation may be done by posting defined questions to a set of crowd in the crowdsourced network and receiving responses from them. In such cases, the crowd includes credentialed experts who may be considered only when they bear a threshold score of officiality, reputations and the credentialed expertise as already determined and discussed elsewhere in this document. The questions may be defined and rank ordered according to their perceived importance for the initiative or sub-innovation under evaluation. Based on the rank, questions may be scored in a weighted fashion. For example, a question of rank order 1 can contribute more to the non-obviousness score than the non-obviousness question of rank order 5. The assessment and evaluation is designed to yield a minimum threshold score to qualify an innovation or a sub-innovation or any other initiative as non-obvious. In some embodiments, the non-obviousness assessment may be done by the obviousness decision module 212 by utilizing machine learning and automated search capabilities that result in identification of prior art relevant to various initiatives under consideration including the tracked sub-innovations.

The evaluation module 202 may be coupled to a revenue assessment engine 214 that may be used to assess potential revenue that can be aggregated from implementation of an initiative. The revenue assessment may be done by posting defined questions to a set of crowd in the crowdsourced network and receiving responses from them. In such cases, the crowd includes credentialed experts who may be considered only when they bear a threshold score of officiality, reputations and the credentialed expertise as already determined and discussed elsewhere in this document. The questions may be defined and rank ordered according to their perceived importance for the initiative or sub-innovation under evaluation. Based on the rank, questions may be scored in a weighted fashion. The assessment and evaluation is designed to yield a minimum threshold score to qualify an innovation or a sub-innovation or any other initiative as potential enough to generate desired revenues. The revenue assessment may include projecting revenues to be generated from licensing the initiative such as a sub-innovation and projecting revenue to be generated from enforcing intellectual property contained within the initiative. The revenue assessment engine 214 may include or be coupled to a market assessment engine 216. The market assessment engine 216 may determine market potential. An output from the market assessment engine 216 may be used by the revenue assessment engine 214 such that the revenue assessment engine 214 may determine the revenue based on market potential and various other inputs. The market assessment engine 216 evaluates a market for defined market parameters related to the initiative under consideration so as to determine value of an initiative for a target market.

The market assessment may be performed by posting defined questions to a set of crowd in the crowdsourced network 104 and receiving responses from them. In such cases, the crowd includes credentialed experts who may be considered only when they bear a threshold score of officiality, reputations and the credentialed expertise as already determined and discussed elsewhere in this document. The questions may be defined and rank ordered according to their perceived importance for the initiative or sub-innovation under evaluation. Based on the rank, questions may be scored in a weighted fashion.

The evaluation module 202 may be coupled to a significance determination engine 218 that determines significance of an initiative for a target venture, or third party interested in borrowing the initiative from the innovator. For example, the initiatives may be submitted to an agency for the purpose of grants and financial aids. In such cases, the significance determination engine 218 may evaluate the initiative such as a sub-innovation in light of the requirements of the target agency and accordingly define a monetary value of grant or financial aid. The significance determination may be done by posting defined questions to a set of crowd in the crowdsourced network and receiving responses from them. In such cases, the crowd includes credentialed experts who may be considered only when they bear a threshold score of officiality, reputations and the credentialed expertise as already determined and discussed elsewhere in this document. The questions may be defined and rank ordered according to their perceived importance for the initiative or sub-innovation under evaluation. Based on the rank, questions may be scored in a weighted fashion.

The evaluation module 202 uses the various inputs as determined from various engines and modules discussed above to evaluate an initiative. The evaluation process yields an evaluation output which may be used an as input by the scoring module 204.

The scoring module or the initiatives scoring module 204 associates an aggregate score to the initiative based on the evaluation by the evaluation module 204 on one or more inputs as discussed above.

In accordance with some embodiments as discussed above, the aggregate score of an initiative (ASI) for one or more inputs may be determined based on an empirical relation. An exemplary empirical relation may be as follows:

ASI=EW1+RW2+OW3+BW4+NW5+VW6+SW7+MW8

Above, ‘E’ represents credentialed expertise, ‘R’ represents reputation, ‘O’ represents officiality, ‘B’ represents non-obviousness input, ‘N’ represents novelty input, ‘V’ represents revenue input, ‘S’ represents significance input, ‘M’ represents market input and W1, W2, W3, W4, W5, W6, W7, and W8 represent weightages of the respective inputs. In other embodiments, other similar empirical or non-empirical relationships with modifications may be considered without limitations.

In accordance with some embodiments as discussed above, the credentialing engine may evaluate the credentialed expertise (E) for the expert based on an empirical relation. In an example, the empirical relation can be as follows:

E=(PF11+PF12+ . . . +PF1N)×(PF21+PF22+ . . . PF2N)× . . . ×(PFZ1+PFZ2 + . . . +PFZN)

### Above,

PF11 represents credentialed federated profile score for a first federated profile of a first expert by a first respondent,
PF12 represents credentialed federated profile score for the first federated profile of the first expert by a second respondent,
PF1N represents credentialed federated profile score for the first federated profile of the first expert by an Nth respondent,
PF21 represents credentialed federated profile score for a second federated profile of the first expert by the first respondent,
PF22 represents credentialed federated profile score for the second federated profile of the first expert by the second respondent,
PF2N represents credentialed federated profile score for the second federated profile of the first expert by the Nth respondent,
PFZ1 represents credentialed federated profile score for a Zth federated profile of the first expert by the first respondent,
PFZ2 represents credentialed federated profile score for the Zth federated profile of the first expert by the second respondent, and
PFZN represents credentialed federated profile score for the Zth federated profile of the first expert by the Nth respondent.

In an example, the empirical relation above considers profiles scores for entire federated profiles from 1 to Z. In an example, the empirical relation above considers all respondents from 1 to N. In accordance with other embodiments, other similar empirical or non-empirical relationships with modifications may be considered without limitations.

In accordance with some embodiments as discussed above, the scoring engine 204 evaluates aggregate crowdsourced document score (ACDS) based on credentialed expertise and other attributes of the crowdsourced experts, based on an empirical relation. An exemplary relation can be as follows:

ACDS={(E1+E2+E3+ . . . +EX)W1+(R1+R2+R3++RX)W2+(O1+O2+O3+ . . . +OX)W3}(D1+D2+D3+ . . . +DX)CI

E1, E2, E3, . . . EX represent respective credentialed expertise of X number of crowdsourced experts,
R1, R2, R3, . . . RX represent respective reputation of the X number of crowdsourced experts,
O1, O2, O3, . . . OX represent respective officiality of the X number of crowdsourced experts,
D1, D2, D3 . . . DX represent respective document scores earned by the X number of crowdsourced experts, and
CI represents Non-Linear Crowdsourcing Index.

In other embodiments, other similar empirical or non-empirical relationships with modifications may be considered without limitations.

In some embodiments, the CI is defined non-linearly with integral ranges (R) of experts who credential the document. In an example, first five of the ranges can be as follows without limitations:

CI=1, when R=0-2 experts,
CI=1.2, when R=3-4 experts,
CI=1.5, when R=5-6 experts
CI=1.9, when R=7-8 experts, and
CI=2.5, when R=9-10 experts.

In an example, the CI may be calculated based on an empirical relationship that dynamically determines value of the CI with every integral change in number of expert credentialing the document.

The embodiments herein can employ other empirical and non empirical tools for evaluation of the various inputs and scoring of the initiatives that is innovations and their respective sub-innovations.

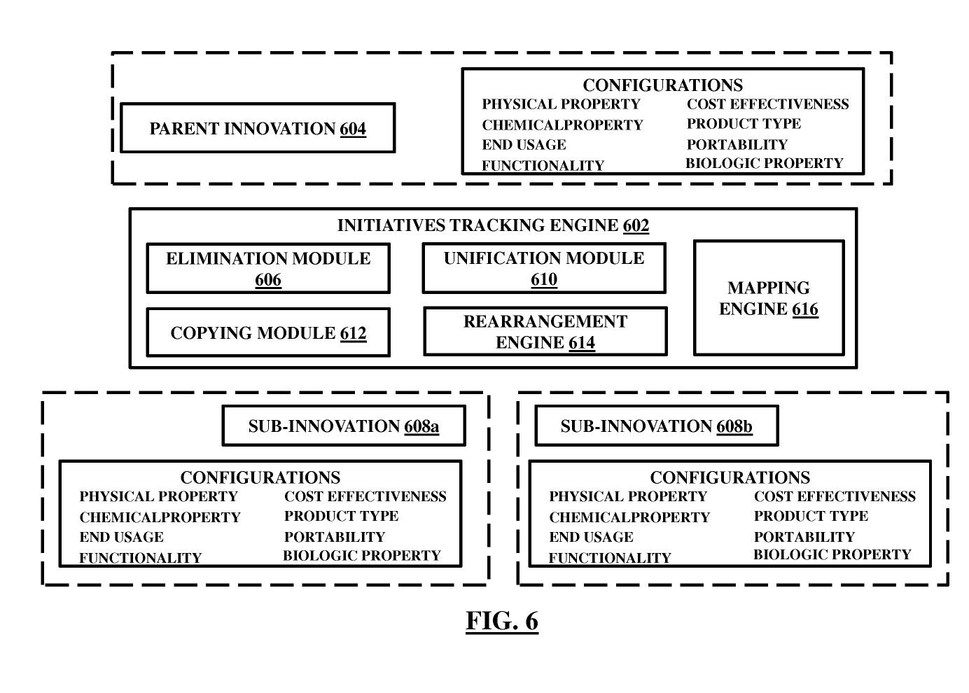

FIG. 6, with reference to FIGS. 1 through 5, illustrates an exemplary initiatives tracking engine 602 for developing or tracking sub-innovations by each of the innovations in the crowdsourced initiatives exchange network 104. In an example, the initiatives are developed or tracked by performing a set of automated tasks aiming to change configurations of a parent innovation 604 in at least one of the attributes or elements such that the resulting sub-innovation is different from the parent innovation 604 in at least one of the categories including physical property, chemical property, biologic property, end usage, functionality, portability, cost effectiveness, and product type and bear a similarity relationship thread with the parent invention 604.

In an embodiment, the initiatives tracking engine 602 includes an elimination module 606. The elimination module 606 tracks sub-innovations for the innovation 604 by removing seemingly essential elements or attributes from the parent innovation 604 such that the sub-innovations 608a and 608b have at least one element reduced from the innovation 604 and results in a tangible product that is different from the parent innovation 604 in at least one of the categories including physical property, chemical property, biologic property, end usage, functionality, portability, cost effectiveness, and product type.

In an embodiment, the initiatives tracking engine 602 includes a unification module 610. The unification module 610 tracks sub-innovations 608a and 608b for the innovation 604 by adding seemingly dissimilar and unrelated attributes or elements with the parent innovation 604 such that the sub-innovations 608a and 608b have at least one element or attribute added to the parent innovation 604 and results in a tangible product that is different from the parent innovation 604 in at least one of the categories including physical property, chemical property, biologic property, end usage, functionality, portability, cost effectiveness, and product type.

In an embodiment, the initiatives tracking engine 602 includes a copying module 612. The copying module 612 tracks sub-innovations 608a and 608b for the parent innovation 604 by copying attributes or elements of the parent innovation 604 and making alterations into it to result in sub-innovations 608a and 608b that are different from the parent innovation 604 in at least one of the categories including physical property, chemical property, biologic property, end usage, functionality, portability, cost effectiveness, and product type.

In an embodiment, the initiatives tracking engine 604 includes a rearrangement engine 614. The rearrangement engine 614 tracks sub-innovations 608a and 608b for an innovation by rearranging attributes or elements of the parent innovation 604 in a substantially different manner to result in the sub-innovations 608a and 608b that are different from the parent innovation 604 in at least one of the categories including physical property, chemical property, biologic property, end usage, functionality, portability, cost effectiveness, and product type, wherein the rearrangement can be of a physical or a chemical type such that the physical rearrangement results in a different physical product and a chemical rearrangement results in a different molecule or compound.

In an example, the initiative or the innovation is a transition sunglass that changes color with sunlight effects. The initiatives tracking engine performs one or more of the operations as discussed above using one or more of the modules and engines as discussed above on the parent innovation to yield a sub-innovation corresponding to the parent innovation. For example, a resulting sub-innovation in the example herein is an air conditioner unit that changes temperature settings based on an external environment temperature and moisture content. The similarity relationship thread between the innovation and the sub-innovation in the example herein is an external environment transition. The similarity relationship of the external environment transition allows developing or tracking a plurality of sub-innovations in a hierarchical series such that each corresponding sub-innovation derived from a respective parent innovation bears the same similarity relationship. The respective sub-innovations are derived by eliminating, unifying, copying or rearranging attributes or elements in the respective parent inventions within the hierarchical series. In other embodiments, various other examples may be possible without limitations based on the innovation and the various operations performed on the parent innovation.

The hierarchical series may include a parent innovation and a first sub innovation at level 2 of the series after unification operation on the parent innovation. The hierarchical series may include a second sub-innovation at level 2 of the series after elimination operation on the parent innovation. The hierarchical series may include a first sub-innovation at level 3 of the series obtained after performing copying operation on the second sub-innovation at level 2 series. The hierarchical series may further include a second sub-innovation at level 3 series obtained after performing rearrangement operation on the second sub-innovation at level 2 series. The hierarchical series may further include a third sub-innovation at level 3 of the series obtained after performing copying or elimination operation on the first sub-innovation at level 2 series. In a similar manner, a plurality of innumerable sub-innovations may be derived by the parent innovations. The tracking engine 602 thus provides a multi-level and series-based facility to track or develop a plurality of sub-innovations by the parent innovations by applying one or more operations using one or more of the modules as discussed above. In some other embodiments, still other operations may be employed other than those discussed above. For example, in an embodiment other operations may include without limitations reversing of an initiative through multiple stages to yield change at one or more of the reversed stages.

In an embodiment, an innovation is a transition sunglass that changes color with sunlight effects. A resulting sub-innovation is an air conditioning unit that changes temperature settings based on an external environment temperature and moisture content. The similarity relationship thread between the innovation and the sub-innovation is an external environment transition. The similarity relationship of the external environment transition allows developing or tracking a plurality of sub-innovations in a hierarchical series such that each corresponding sub-innovation derived from a respective parent innovation bears unique and different similarity relationships. The respective sub-innovations are derived by eliminating, unifying, copying or rearranging attributes or elements in the respective parent inventions within the hierarchical series. In the example above, the unique and different similarity relationships in the series between an innovation and a sub-innovation include the external environment transition such that the innovation and its respective sub-innovation exhibit an innovative change by sensing an impact due to the external environmental transition.

In another example, the unique and different similarity relationship in the series between an innovation and a sub-innovation includes weight such that the innovation and its respective sub-innovation exhibit an innovative change by sensing an impact due to an inherent weight of an element.

In still another example, the unique and different similarity relationship between an innovation and a sub-innovation includes physical sensation such that the innovation and its respective sub-innovation exhibit an innovative change by sensing an impact due to the physical sensation of a body from an element or event.

In still another example, the unique and different similarity relationship between an innovation and a sub-innovation includes occurrence of an event such that the innovation and its respective sub-innovation exhibit an innovative change by sensing an impact due to the occurrence of the event.

In still another example, the unique and different similarity relationship between an innovation and a sub-innovation includes shape such that the innovation and its respective sub-innovation exhibit an innovative change by sensing an impact due to the shape of an element.

In still another example, the unique and different similarity relationship between an innovation and a sub-innovation includes optics such that the innovation and its respective sub-innovation exhibit an innovative change by sensing an impact due to optical attributes.

In still another example, the unique and different similarity relationship between an innovation and a sub-innovation includes element count such that the innovation and its respective sub-innovation exhibit an innovative change by sensing an impact due to a change in the element count.

In still another example, the unique and different similarity relationship between an innovation and a sub-innovation includes angular orientations such that the innovation and its respective sub-innovation exhibit an innovative change by sensing an impact due to a change in the angular orientations.

In still another example, the unique and different similarity relationship between an innovation and a sub-innovation includes size of an element such that the innovation and its respective sub-innovation exhibit an innovative change by sensing an impact due to a change in the element size.

In still another example, the unique and different similarity relationship between an innovation and a sub-innovation includes speed such that the innovation and its respective sub-innovation exhibit an innovative change by sensing an impact due to speed of an element. Still, there may be various other similarity relationships between an innovation and its respective sub-innovation. Any of these various similarity relationships discussed here can be kept constant during innovation tracking so as to result in a sub-innovation with the same similarity relationship as its parent innovation.

In an example, the processing circuit 112 as shown in FIG. 1 may be coupled to the tracking engine 602 and a memory circuit (not shown) for storing programmed instructions that perform defined tasks of elimination, unification, copying and rearrangement within one or more attributes or elements of the parent innovation to derive a plurality of sub-innovations different in one or both of obviousness and novelty and bearing at least one similarity relationship with the parent innovation. In an example, the derived sub-innovations include a first sub-innovation derived from the parent innovation with a similarity relationship between the first sub-innovation and the second sub-innovation, the derived sub-innovations further includes a second sub-innovation derived from the first sub-innovation based on a similarity relationship between the second sub-innovation and the first sub-innovation. The first similarity relationship and the second similarity relationship are different. The derived sub-innovations further include a third sub-innovation derived from the second sub-innovation based on a third similarity relationship between the second sub-innovation and the third sub-innovation such that the third similarity relationship is different from the first and second similarity relationships. The parent innovation, first sub-innovation, second sub-innovation, and the third sub-innovation are non-obvious and novel among themselves.

The tracking engine 602 may further include a mapping engine 616 that develops an initiatives map including the parent innovation and the sub-innovations along with their similarity relationships to define relationship trends in the series of the tracked innovations at each level of the series. The processing circuit 112 may use the relationships trends and the map to further evolve mechanism of tracking and developing the sub-innovations from a parent innovation. The processing circuit 112 may utilize the trends and the map as a template for defining sub-innovations and evaluating the sub-innovations based on obviousness and novelty criteria and various other criteria.

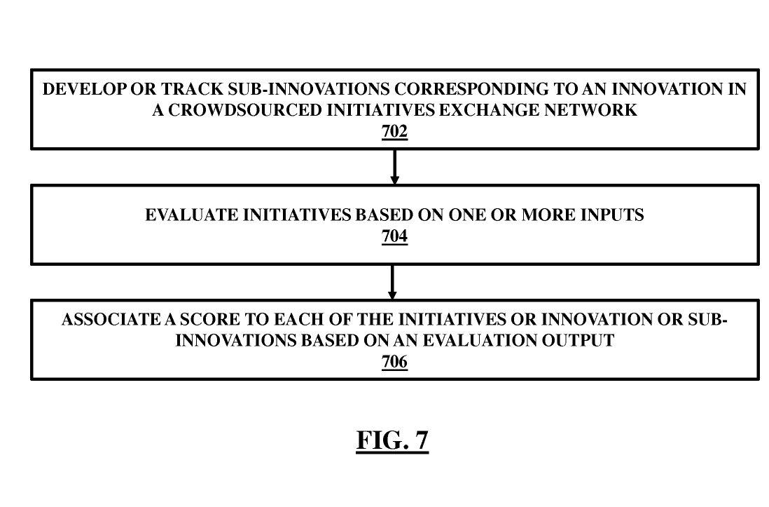

FIG. 7, with reference to FIGS. 1 through 6, illustrates a method flowchart for tracking or developing and scoring of sub-innovations from an innovation in the initiatives exchange ecosystem 100. The method includes at step 702 developing or tracking sub-innovations corresponding to an innovation in the crowdsourced initiatives exchange network 104. The initiatives are developed or tracked by performing a set of automated tasks aiming to change configurations of a parent innovation in at least one of the attributes or elements such that the resulting sub-innovation is different from the parent innovation in at least one of defined categories. The define categories may include without limitations physical property, chemical property, biologic property, end usage, functionality, portability, cost effectiveness, and product type. In an embodiment, the sub-innovations may bear a similarity relationship thread with the parent invention.

At step 704, the method includes evaluating the initiatives (sub-innovations) based on one or more inputs. The one or more inputs can include without limitations credentialed score, officiality, and reputation of the innovator, novelty search output, non-obviousness decision, significance of the initiatives for a target agency, revenue potential, and market coverage, and the like.

At step 706, the method includes associating a score to each of the initiatives or innovation or sub-innovations based on an evaluation output.

In some embodiments, the method may further include determining the credentialed expertise of an innovator based on responses from crowdsourced respondents or experts such that the crowdsourced respondents respond to federated profiles associated with the innovator and credential the innovator. The credentialing of each of said federated profiles associated with the innovator contribute to credentialing of an entire common profile of the innovator upon collation of the credentialed federated profiles. A crowdsourcing index may be associated with the credentialing process that is indicative of a degree of crowdsourcing such that the degree of crowdsourcing non-linearly affects the degree of credentialing. The method may further include fragmenting the profile of the innovator into the federated profiles by the federation engine based on commonalities in content of the federated profiles. The federated profiles may be treated as distinct profiles associated with the innovator.

In some embodiments, the tracking of sub-innovations from a parent innovation may include removing seemingly essential elements or attributes from the parent innovation such that the sub-innovations have at least one element reduced from the innovation and results in a tangible product that is different from the parent innovation in at least one of the categories including physical property, chemical property, biologic property, end usage, functionality, portability, cost effectiveness, and product type. In some embodiments, the tracking of sub-innovations from a parent innovation may include adding seemingly dissimilar and unrelated attributes or elements with the parent innovation such that the sub-innovations have at least one element or attribute added to the parent innovation and results in a tangible product that is different from the parent innovation in at least one of the categories including physical property, chemical property, biologic property, end usage, functionality, portability, cost effectiveness, and product type. In some embodiments, the tracking of sub-innovations from a parent innovation may include copying attributes or elements of a parent innovation and making alterations into it to result in a sub-innovation that is different from the parent innovation in at least one of the categories including physical property, chemical property, biologic property, end usage, functionality, portability, cost effectiveness, and product type. In some embodiments, the tracking of sub-innovations from a parent innovation may include eliminating attributes or elements of a parent innovation and rearranging them in a substantially different manner to result in a sub-innovation that is different from the parent innovation in at least one of the categories including physical property, chemical property, biologic property, end usage, functionality, portability, cost effectiveness, and product type. The rearrangement can be of a physical or a chemical type such that the physical rearrangement results in a different physical product and a chemical rearrangement results in a different molecule or compound. In some embodiments, the various tasks may be performed by the initiatives tracking engine that may be coupled to or be included within the processing circuit. The processing circuit 112 may further be coupled to the memory circuit.

The embodiments herein may be embodied as a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

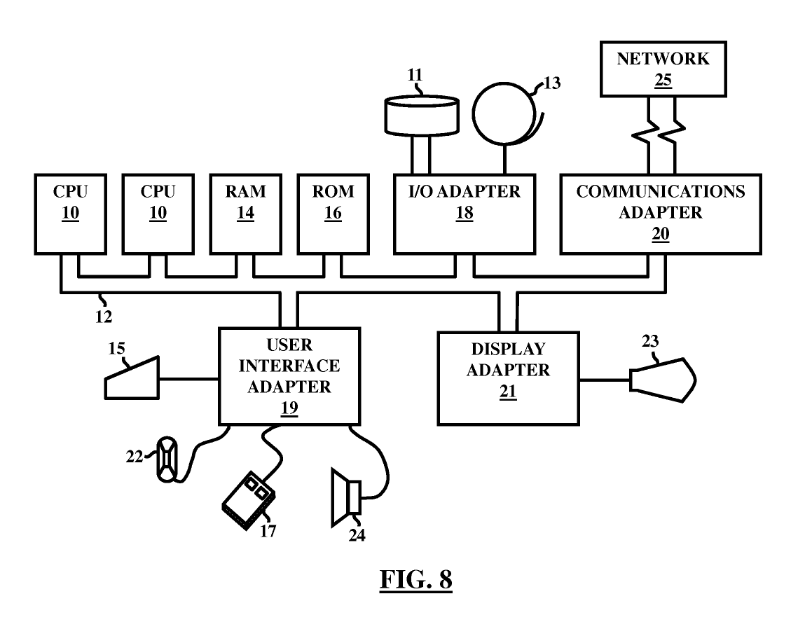

A representative hardware environment for practicing the embodiments herein is depicted in FIG. 8, with reference to FIGS. 1 through 7. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An initiatives exchange ecosystem comprising:
a computing device operatively connected to a crowdsourced initiatives exchange network, wherein said initiatives include an innovation and corresponding sub-innovations such that each innovation tracks sub-innovations;
a web platform accessible through a user interactive interface through said computing device;
a processing circuit including or coupled to:
an initiatives tracking engine that develops or tracks sub-innovations corresponding to an innovation in said crowdsourced initiatives exchange network, wherein said initiatives are developed or tracked by performing a set of automated tasks aiming to change configurations of a parent innovation in at least one of said attributes or elements such that said resulting sub-innovation is different from said parent innovation in at least one of said categories including physical property, chemical property, biologic property, end usage, functionality, portability, cost effectiveness, and product type and bear a similarity relationship thread with said parent invention; and
a central initiatives management engine including:
an evaluation module for evaluating said initiatives based on one or more inputs; and
a scoring module for associating a score to each of said initiatives based on an evaluation output;
an enterprise asset library to serve as a knowledge repository for storing information pertinent to said initiatives including initiatives documents, invention disclosures, innovator profiles, innovator credentialing details, said evaluation output, and said associated scores;
a financial transaction engine coupled to said processing circuit for:
exploring a plurality of target agency requirements within and outside said initiatives exchange network;
determining a degree of relevance of an initiative with said target agency requirements; and
determining a financial value of said initiative for said target agency;
an initiatives transfer engine for facilitating transfer of rights associated with said initiatives once said financial transaction is settled.

2. The ecosystem of claim 1, wherein one or more inputs including officiality of an innovator, reputation of an innovator, and credentialed expertise of an innovator are used as inputs to said evaluation module for assessing said innovation asset.

3. The ecosystem of claim 1, wherein one or more inputs including novelty search output, non-obviousness decision, significance of said innovation assets for a target agency, revenue potential, and market coverage are further used as inputs by said evaluation module to evaluate said innovation asset by said innovator.

4. The ecosystem of claim 1, wherein said initiatives tracking engine tracks sub-innovations for an innovation by removing seemingly essential elements or attributes from said parent innovation such that said sub-innovations have at least one element reduced from said innovation and results in a tangible product that is different from said parent innovation in at least one of said categories including physical property, chemical property, biologic property, end usage, functionality, portability, cost effectiveness, and product type.

5. The ecosystem of claim 1, wherein said initiatives tracking engine tracks sub-innovations for an innovation by adding seemingly dissimilar and unrelated attributes or elements with said parent innovation such that said sub-innovations have at least one element or attribute added to said parent innovation and results in a tangible product that is different from said parent innovation in at least one of said categories including physical property, chemical property, biologic property, end usage, functionality, portability, cost effectiveness, and product type.

6. The ecosystem of claim 1, wherein said initiatives tracking engine tracks sub-innovations for an innovation by copying attributes or elements of a parent innovation and making alterations into it to result in a sub-innovation that is different from said parent innovation in at least one of said categories including physical property, chemical property, biologic property, end usage, functionality, portability, cost effectiveness, and product type.

7. The ecosystem of claim 1, wherein said initiatives tracking engine tracks sub-innovations for an innovation by eliminating attributes or elements of a parent innovation and rearranging them in a substantially different manner to result in a sub-innovation that is different from said parent innovation in at least one of said categories including physical property, chemical property, biologic property, end usage, functionality, portability, cost effectiveness, and product type, wherein said rearrangement can be of a physical or a chemical type such that said physical rearrangement results in a different physical product and a chemical rearrangement results in a different molecule or compound.

8. The ecosystem of claim 1, wherein an innovation comprises a transition sunglass that changes color with sunlight effects, wherein a resulting sub-innovation comprises an air conditioning unit that changes temperature settings based on an external environment temperature and moisture content, wherein said similarity relationship thread between said innovation and said sub-innovation comprises an external environment transition, said similarity relationship of said external environment transition further allowing developing or tracking a plurality of sub-innovations in a hierarchical series such that each corresponding sub-innovation derived from a respective parent innovation bears said same similarity relationship, and wherein said respective sub-innovations are derived by either eliminating, unifying, or rearranging attributes or elements in said respective parent inventions within said hierarchical series.

9. The ecosystem of claim 1, wherein an innovation comprises a transition sunglass that changes color with sunlight effects, wherein a resulting sub-innovation comprises an air conditioning unit that changes temperature settings based on an external environment temperature and moisture content, wherein said similarity relationship thread between said innovation and said sub-innovation comprises an external environment transition, said similarity relationship of said external environment transition further allowing developing or tracking a plurality of sub-innovations in a hierarchical series such that each corresponding sub-innovation derived from a respective parent innovation bears unique and different similarity relationships, and wherein said respective sub-innovations are derived by either eliminating, unifying, or rearranging attributes or elements in said respective parent inventions within said hierarchical series.

10. The ecosystem of claim 9, wherein said unique and different similarity relationship in said series between an innovation and a sub-innovation includes said external environment transition such that said innovation and its respective sub-innovation exhibits an innovative change by sensing an impact due to said external environmental transition.

11. The ecosystem of claim 1, wherein said processing circuit is further coupled to a memory circuit for storing programmed instructions that perform defined tasks of elimination, unification, and rearrangement within one or more attributes or elements of said parent innovation to derive a plurality of sub-innovations different in one or both of obviousness and novelty and bearing at least one similarity relationship.

12. The ecosystem of claim 11, wherein said derived sub-innovations include a first sub-innovation derived from said parent innovation with a similarity relationship between said first sub-innovation and said second sub-innovation, said derived sub-innovations further including a second sub-innovation derived from said first sub-innovation based on a similarity relationship between said second sub-innovation and said first sub-innovation, wherein said first similarity relationship and said second similarity relationship are different, said derived sub-innovations further including a third sub-innovation derived from said second sub-innovation based on a third similarity relationship between said second sub-innovation and said third sub-innovation such that said third similarity relationship is different from said first and second similarity relationships, wherein said parent innovation, first sub-innovation, second sub-innovation, and said third sub-innovation are non-obvious and novel among themselves.

13. The ecosystem of claim 12, further comprising a mapping system that develops an initiatives map including said parent innovation and said sub-innovations along with their similarity relationships to define relationship trends.

14. A method for tracking or developing and scoring sub-innovations from an innovation in an initiatives exchange ecosystem, said method comprising:
developing or tracking sub-innovations corresponding to an innovation in the crowdsourced initiatives exchange network, wherein said initiatives are developed or tracked by performing a set of automated tasks aiming to change configurations of a parent innovation in at least one of said attributes or elements such that said resulting sub-innovation is different from said parent innovation in at least one of said categories including physical property, chemical property, biologic property, end usage, functionality, portability, cost effectiveness, and product type and bear a similarity relationship thread with said parent invention;
evaluating said initiatives based on one or more inputs, wherein said one or more inputs include credentialed score, officiality, and reputation of said innovator, novelty search output, non-obviousness decision, significance of said initiatives for a target agency, revenue potential, and market coverage;
associating a score to each of said initiatives based on an evaluation output; and
outputting said score to a computing device.

15. The method of claim 14, further comprising removing seemingly essential elements or attributes from said parent innovation such that said sub-innovations have at least one element reduced from said innovation and results in a tangible product that is different from said parent innovation in at least one of said categories including physical property, chemical property, biologic property, end usage, functionality, portability, cost effectiveness, and product type.

16. The method of claim 14, further comprising adding seemingly dissimilar and unrelated attributes or elements with said parent innovation such that said sub-innovations have at least one element or attribute added to said parent innovation and results in a tangible product that is different from said parent innovation in at least one of said categories including physical property, chemical property, biologic property, end usage, functionality, portability, cost effectiveness, and product type.

17. The method of claim 14, further comprising copying attributes or elements of a parent innovation and making alterations into it to result in a sub-innovation that is different from said parent innovation in at least one of said categories including physical property, chemical property, biologic property, end usage, functionality, portability, cost effectiveness, and product type.

18. The method of claim 14, further comprising rearranging attributes or elements of a parent innovation in a substantially different manner to result in a sub-innovation that is different from said parent innovation in at least one of said categories including physical property, chemical property, biologic property, end usage, functionality, portability, cost effectiveness, and product type, wherein said rearrangement can be of a physical or a chemical type such that said physical rearrangement results in a different physical product and a chemical rearrangement results in a different molecule or compound.

19. A non-transitory program storage device readable by computer, and comprising a program of instructions executable by said computer to perform a method for tracking or developing and scoring sub-innovations from an innovation in an initiatives exchange ecosystem, said method comprising:
developing or tracking sub-innovations corresponding to an innovation in said crowdsourced initiatives exchange network, wherein said initiatives are developed or tracked by performing a set of automated tasks aiming to change configurations of a parent innovation in at least one of said attributes or elements such that said resulting sub-innovation is different from said parent innovation in at least one of said categories including physical property, chemical property, biologic property, end usage, functionality, portability, cost effectiveness, and product type and bear a similarity relationship thread with said parent invention;
evaluating said initiatives based on one or more inputs, wherein said one or more inputs include credentialed score, officiality, and reputation of said innovator, novelty search output, non-obviousness decision, significance of said initiatives for a target agency, revenue potential, and market coverage; and
associating a score to each of said initiatives based on an evaluation output.

20. The program storage device of claim 19, wherein said method further comprising one or more of:
removing seemingly essential elements or attributes from said parent innovation such that said sub-innovations have at least one element reduced from said innovation and results in a tangible product that is different from said parent innovation in at least one of said categories including physical property, chemical property, biologic property, end usage, functionality, portability, cost effectiveness, and product type;
adding seemingly dissimilar and unrelated attributes or elements with said parent innovation such that said sub-innovations have at least one element or attribute added to said parent innovation and results in a tangible product that is different from said parent innovation in at least one of said categories including physical property, chemical property, biologic property, end usage, functionality, portability, cost effectiveness, and product type;
copying attributes or elements of a parent innovation and making alterations into it to result in a sub-innovation that is different from said parent innovation in at least one of said categories including physical property, chemical property, biologic property, end usage, functionality, portability, cost effectiveness, and product type; and
rearranging attributes or elements of a parent innovation in a substantially different manner to result in a sub-innovation that is different from said parent innovation in at least one of said categories including physical property, chemical property, biologic property, end usage, functionality, portability, cost effectiveness, and product type, wherein said rearrangement can be of a physical or a chemical type such that said physical rearrangement results in a different physical product and a chemical rearrangement results in a different molecule or compound.
